(19) United States
(12) Patent Application Publication
(10) Pub. No.: US 2018/0191435 A1
(43) Pub. Date: Jul. 5, 2018

(54) POWER-EFFICIENT VISIBLE LIGHT COMMUNICATION (VLC) SCANNING

(71) Applicant: QUALCOMM Incorporated, San Diego, CA (US)

(72) Inventors: Bapineedu Chowdary Gummadi, Hyderabad (IN); Ravi Shankar Kadambala, Hyderabad (IN); Vivek Veenam, Hyderabad (IN)

(21) Appl. No.: 15/394,021

(22) Filed: Dec. 29, 2016

(51) Int. Cl. H04B 10/116; H04W 4/02

(52) U.S. Cl. CPC H04B 10/116; H04W 84/12; H04W 4/02

(57) ABSTRACT

Disclosed are systems and methods for power efficient visible light communication (VLC) scanning. In an aspect, a mobile device determines that the mobile device has lost view of a VLC light source, turns on, in response to determining that the mobile device has lost view of the VLC light source, a camera of the mobile device in a low-resolution mode to scan for any VLC light sources within view of the mobile device, and switches, based on detecting a detected VLC light source, the camera of the mobile device to a high-resolution mode to decode VLC signals from the detected VLC light source.

### INTRODUCTION

Aspects relate to power-efficient visible light communication (VLC) scanning.

Determining the position of a mobile device in an indoor environment can be useful in a number of applications, such as navigating mobile phone users in office/commercial environments, enabling customers to find items in a supermarket or retail outlet, coupon issuance and redemption, customer service and accountability, etc. However, achieving precise position estimates can be a challenging task. Indoor positioning is typically achieved using radio frequency (RF) signals received from Wi-Fi access points (or similar means). A drawback to this technique is that it requires mobile devices to learn RF signal propagation parameters, which presents a significant technical challenge for achieving high precision (e.g., less than one meter) position accuracy.

To provide greater indoor positioning accuracy, visible light communication (VLC) is being developed to transmit identification information for positioning operations by using variations of visible light (color, intensity, or position). Such communication technology for transmitting identification information is based on high-frequency blinking visible lights, referred to as VLC light sources. Specifically, the identification information to be transmitted is compiled into a digital signal. The digital signal is then applied to modulate the duration time or frequency of the driving current or driving voltage of the VLC light source, causing the VLC light source to blink at a high frequency. This high-frequency blinking signal can be detected by a photosensitive device, for example, an image sensor (e.g., a camera of a smartphone). By detecting the light signals from one or more VLC light sources, a mobile device can determine its position to a high degree of accuracy (e.g., within centimeters).

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for power efficient visible light communication (VLC) scanning performed at a mobile device includes determining that the mobile device has lost view of a VLC light source, in response to determining that the mobile device has lost view of the VLC light source, turning on a camera of the mobile device in a low-resolution mode to scan for any VLC light sources within view of the mobile device, and based on detecting a detected VLC light source, switching the camera of the mobile device to a high-resolution mode to decode VLC signals from the detected VLC light source.

In an aspect, an apparatus for power efficient VLC scanning includes at least one processor of a mobile device configured to: determine that the mobile device has lost view of a VLC light source, turn on, in response to determining that the mobile device has lost view of the VLC light source, a camera of the mobile device in a low-resolution mode to scan for any VLC light sources within view of the mobile device, and switch, based on detecting a detected VLC light source, the camera of the mobile device to a high-resolution mode to decode VLC signals from the detected VLC light source.

In an aspect, a non-transitory computer-readable medium storing computer-executable instructions for power efficient VLC scanning includes computer-executable instructions comprising at least one instruction to cause the mobile device to determine that the mobile device has lost view of a VLC light source, at least one instruction to cause the mobile device to turn on, in response to determining that the mobile device has lost view of the VLC light source, a camera of the mobile device in a low-resolution mode to scan for any VLC light sources within view of the mobile device, and at least one instruction to cause the mobile device to switch, based on detecting a detected VLC light source, the camera of the mobile device to a high-resolution mode to decode VLC signals from the detected VLC light source.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure will be readily obtained as the same becomes better understood by reference to the following detailed description when considered in connection with the accompanying drawings which are presented solely for illustration and not limitation of the disclosure, and in which:

FIG. 1 shows a first block diagram of a wireless communications system in accordance with an aspect of the disclosure.

FIG. 2 shows physical diagram of a number of mobile devices, each of which may be illuminated by one or more of a number of light sources in accordance with various aspects of the disclosure.

FIG. 3 provides an alternative view illustrating a mobile device illuminated by three light sources in accordance with various aspects of the disclosure.

FIG. 4 illustrates an exemplary mobile device that may be used in an operating environment that can determine position using wireless techniques, according to one aspect of the disclosure.

FIG. 5 illustrates an exemplary system according to at least one aspect of the disclosure.

FIG. 6 illustrates an exemplary flow for performing a power-efficient scan for visible light communication (VLC) light sources according to at least one aspect of the disclosure.

FIG. 7 is a flowchart of an exemplary method for power efficient VLC scanning according to an aspect of the disclosure.

FIG. 8 is a simplified block diagram of several sample aspects of an apparatus configured to support communication as taught herein.

### DETAILED DESCRIPTION

Disclosed are systems and methods for power efficient visible light communication (VLC) scanning. In an aspect, a mobile device determines that the mobile device has lost view of a VLC light source, turns on, in response to determining that the mobile device has lost view of the VLC light source, a camera of the mobile device in a low-resolution mode to scan for any VLC light sources within view of the mobile device, and switches, based on detecting a VLC light source, the camera of the mobile device to a high-resolution mode to decode VLC signals from the detected VLC light source.

These and other aspects of the disclosure are disclosed in the following description and related drawings directed to specific aspects of the disclosure. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

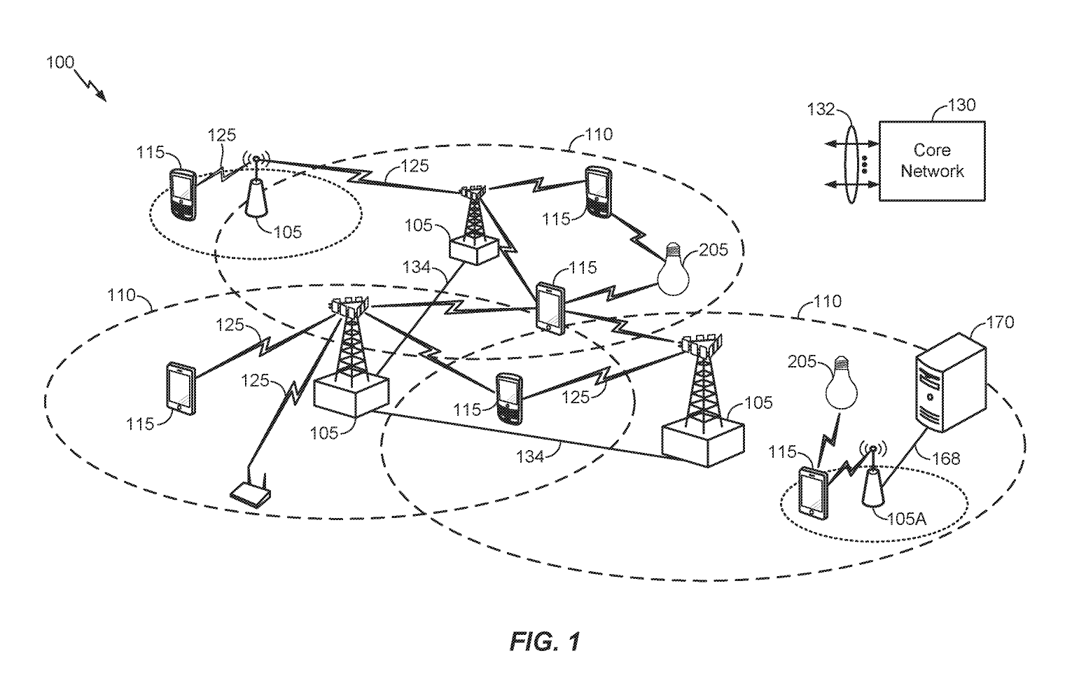

FIG. 1 is a diagram illustrating an example of a wireless communications system 100. The system 100 includes a plurality of access points (e.g., base stations, evolved node Bs (eNBs), or wireless local area network (WLAN) access points) 105, a number of mobile devices 115, and a core network 130. Some of the access points 105 may communicate with the mobile devices 115 under the control of a base station controller (not shown), which may be part of the core network 130 or certain access points 105 (e.g., base stations or eNBs) in various aspects. Some of the access points 105 may communicate control information and/or user data with the core network 130 through backhaul 132. In some aspects, some of the access points 105 may communicate, either directly or indirectly, with each other over backhaul links 134, which may be one or more wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, etc.

The access points 105 may wirelessly communicate with the mobile devices 115 via one or more access point antennas. Each of the access points 105 may provide communication coverage for a respective geographic area 110. In some aspects, an access point 105 may be referred to as a base station, a base transceiver station (BTS), a radio base station, a radio transceiver, a basic service set (BSS), an extended service set (ESS), a NodeB, an evolved NodeB (eNB), a Home NodeB, a Home eNodeB, a WLAN access point, or some other suitable terminology. The coverage area 110 for an access point may be divided into sectors making up only a portion of the coverage area (not shown). The system 100 may include access points 105 of different types (e.g., macro, micro, and/or pico base stations). The access points 105 may also utilize different radio technologies. The access points 105 may be associated with the same or different access networks. The coverage areas of different access points 105, including the coverage areas of the same or different types of access points 105, utilizing the same or different radio technologies, and/or belonging to the same or different access networks, may overlap.

The system 100 may be a heterogeneous network in which different types of access points 105 provide coverage for various geographical regions. For example, each access point 105 may provide communication coverage for a macro cell, a pico cell, a femto cell, and/or other types of cell. A macro cell generally covers a relatively large geographic area (e.g., several kilometers in radius) and may allow unrestricted access by mobile devices 115 with service subscriptions with the network provider. A pico cell would generally cover a relatively smaller geographic area and may allow unrestricted access by mobile devices 115 with service subscriptions with the network provider. A femto cell would also generally cover a relatively small geographic area (e.g., a home) and, in addition to unrestricted access, may also provide restricted access by mobile devices 115 having an association with the femto cell (e.g., mobile devices 115 in a closed subscriber group (CSG), mobile devices 115 for users in the home, and the like). An access point 105 for a macro cell may be referred to as a macro base station. An access point for a pico cell may be referred to as a pico base station. And, an access point for a femto cell may be referred to as a femto base station or a home base station. An access point may support one or multiple (e.g., two, three, four, and the like) cells.

The core network 130 may communicate with the access points 105 via a backhaul 132 (e.g., S1, etc.). The access points 105 may also communicate with one another, e.g., directly or indirectly via backhaul links 134 (e.g., X2, etc.) and/or via backhaul 132 (e.g., through core network 130). The wireless communications system 100 may support synchronous or asynchronous operation. For synchronous operation, the access points 105 may have similar frame timing, and transmissions from different access points 105 may be approximately aligned in time. For asynchronous operation, the access points 105 may have different frame timing, and transmissions from different access points 105 may not be aligned in time. The techniques described herein may be used for either synchronous or asynchronous operations.

The mobile devices 115 may be dispersed throughout the wireless communications system 100, and each mobile device 115 may be stationary (but capable of mobility) or mobile. A mobile device 115 may also be referred to by those skilled in the art as a user equipment (UE), a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A mobile device 115 may be a cellular phone, a personal digital assistant (PDA), a wireless communication device, a handheld device, a tablet computer, a laptop computer, a cordless phone, a wearable item such as a watch or glasses, or the like. A mobile device 115 may be able to communicate with macro base stations, pico base stations, femto base stations, relays, and the like. A mobile device 115 may also be able to communicate over different access networks, such as cellular or other wireless wide area network (WWAN) access networks, or WLAN access networks.

The communication links 125 shown in system 100 may include uplinks for carrying uplink (UL) transmissions (e.g., from a mobile device 115 to an access point 105) and/or downlinks for carrying downlink (DL) transmissions (e.g., from an access point 105 to a mobile device 115). The UL transmissions may also be called reverse link transmissions, while the DL transmissions may also be called forward link transmissions.

A particular small cell access point 105A (e.g., a pico cell, a femto cell, a WiFi access point, etc.) may be located within a venue (e.g., a building, stadium, ship, etc.), not shown in FIG. 1 for simplicity, and connected to a location server 170 over a wired or wireless link 168. The location server 170 may be local to the venue (e.g., physically present at the venue) or remote to the venue (e.g., a third-party server in communication with the small cell access point 105A over, for example, the core network 130). As will be described further herein, the mobile device 115 may obtain location information (also referred to herein as “location identifiers”) for one or more light sources 205 installed in the venue from the location server 170 via the small cell access point 105A. The mobile device 115 may optionally store the obtained location information in a local database. The location information can include location coordinates of the one or more light sources, size (e.g., dimensions) of the one or more light sources, orientation of the one or more light sources, shape of the one or more light sources, or any combination thereof.

In some cases, a mobile device 115 may be capable of receiving information-carrying light signals, such as visible light communication (VLC) signals or infrared signals. VLC uses modulated visible light to transmit data. The VLC light source, such as light source 205, is typically a light-emitting diode (LED), although other sources, such as fluorescent light bulbs, may, in some cases, be utilized. Reception at the mobile device 115 is typically based on photodiodes, either individually or in a digital camera sensor or other array of photodiodes, such as those found in cell phones and digital cameras. Arrays of photodiodes may, in some cases, be utilized to provide multi-channel communication and/or spatial awareness relating to multiple VLC light sources.

When illuminated by a light source 205 capable of transmitting an information-carrying light signal, such as a VLC signal, the mobile device 115 may receive and decode the light signal to obtain identification information for the light source 205. The identification information contained in the light signal may in some cases include a repeated codeword that identifies the light source 205. As will be described further herein, the identification information may enable the mobile device 115 to determine the location of the light source 205 (e.g., by looking up the location in a local database or retrieving the location from the location server 170). By identifying the angle of arrival of the light signal, the mobile device 115 may be able to determine positioning information based on the light signal. In some cases, the positioning information may include a direction of one or more light sources 205 with respect to the mobile device. In some cases, the positioning information may also or alternately include an estimate of the distance from the mobile device 115 to one or more light sources 205. In some cases, the mobile device 115 may receive light signals from more than one light source 205 and determine additional positioning information, such as the location of the mobile device 115.

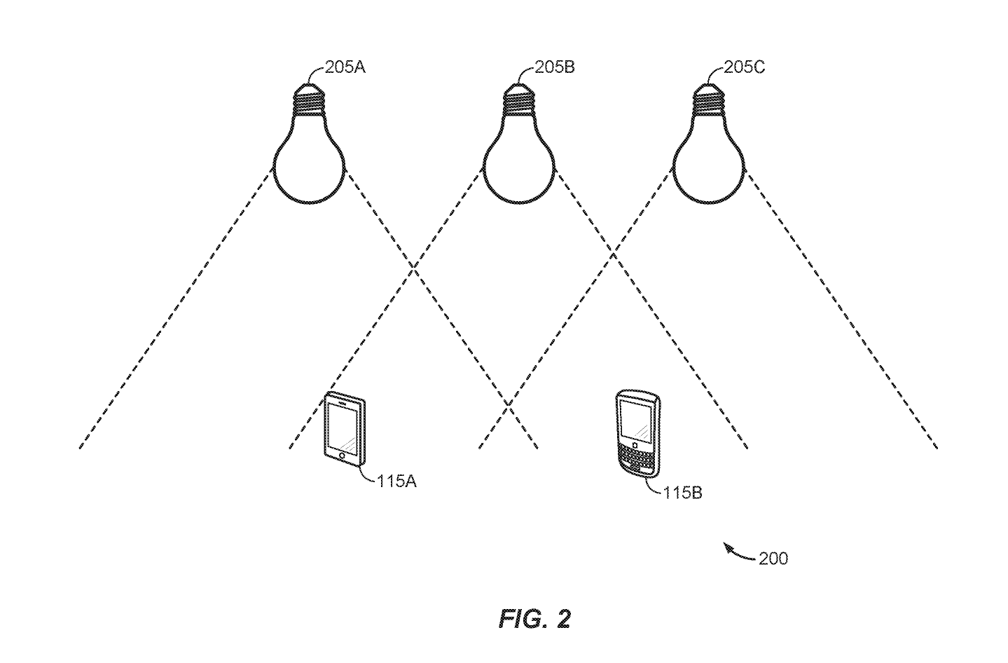

Turning now to FIG. 2, there is shown a physical diagram 200 of a number of mobile devices, represented as mobile devices 115A and 115B, each of which is illuminated by one or more of a number of light sources, represented as light sources 205A, 205B, and 205C. Each of the mobile devices 115A and 115B may be illuminated by one or more of the light sources 205A, 205B, and 205C, with the set of light sources that illuminate a particular one of the mobile devices 115A and 115B changing as the mobile device is moved from one position to another. For example, the mobile device 115A is shown as illuminated by the light sources 205A and 205B, and the mobile device 115B is shown to be illuminated by the light sources 205B and 205C.

The mobile devices 115A and 115B may be examples of the mobile devices 115 described with reference to FIG. 1. The light sources 205A, 205B, and 205C may be examples of the light sources 205 described with reference to FIG. 1, and may take various forms. In some aspects, each light source 205 may be a light emitting diode (LED) luminaire, a compact fluorescent lighting (CFL) luminaire, an incandescent luminaire, and/or another form of luminaire. In some cases, the light sources 205 may be suspended from or mounted on a ceiling, wall, desktop, or other surface. Different light sources may be suspended from or mounted on different surfaces. Each of the light sources 205A, 205B, and 205C may also represent a singular luminaire, a combination of luminaires, or a complex array of luminaires as might be found in a television, computer screen, electronic sign or billboard, etc.

Each of the light sources 205A, 205B, and 205C may contain (or be associated with) circuitry for generating a modulated light signal (e.g., an information-carrying light signal), such as a VLC signal or infrared signal. The modulated light signal may be generated using the primary luminaire of the light source 205A, 205B, and 205C, or using a secondary luminaire, such as a luminaire that is provided particularly for the purpose of generating a modulated light signal. In the latter case, and by way of example, a light source 205 might use a CFL luminaire as its primary light producing mechanism and use a light emitting diode (LED) luminaire particularly for the purpose of generating a modulated light signal.

Each of the mobile devices 115A and 115B may include circuitry for receiving and decoding a modulated light signal. The circuitry may in some cases include an image sensor, such as an image sensor containing an array of photodiodes (e.g., a complementary metal-oxide semiconductor (CMOS) image sensor).

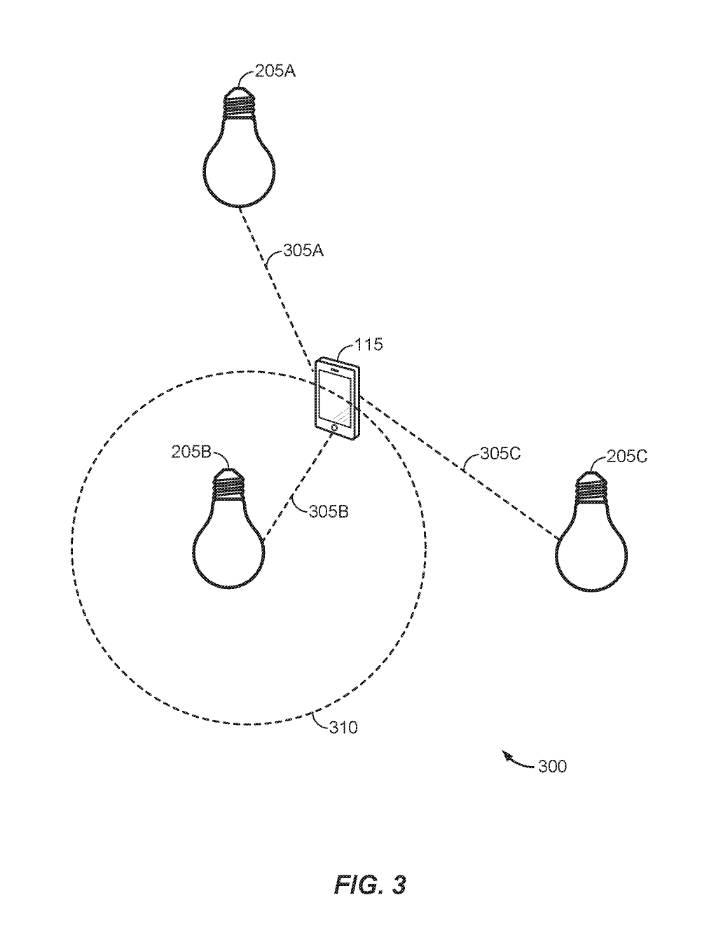

FIG. 3 provides an alternative view 300 illustrating a mobile device 115 illuminated by three light sources 205A, 205B, and 205C. With reference to FIG. 2, the mobile device 115 may be an example of one of the mobile devices 115A and 115B described with reference to FIG. 2. By receiving and decoding the modulated light signal emitted by only one of the light sources (e.g., light source 205B), the mobile device 115 may determine a direction from the mobile device 115 to the light source 205B. By further identifying a location of the light source 205B, the mobile device 115 may estimate a distance 305B from the mobile device 115 to the light source 205B. The distance 305B may indicate that the mobile device 115 is positioned somewhere along the circumference 310.

In an aspect, by receiving and decoding the modulated light signal received from each of the three light sources 205A, 205B, and 205C, identifying a location of each of the three light sources 205A, 205B, and 205C as described herein, and identifying the angle of arrival of the light signal received from each light source 205A, 205B, and 205C, the mobile device 115 may not only estimate the distances 305A, 305B, 305C from the mobile device 115 to each light source 205A, 205B, and 205C, but may also determine a position (e.g., location) of the mobile device 115 (e.g., using trilateration) with a high degree of accuracy (e.g., less than a meter).

Alternatively, where the identification information contained in the light signal from the light source 205B includes information representing the size (e.g., dimensions of the light source such as 24 in×36 in, 12 in diameter, etc.) and shape (e.g., circle, square, rectangle, etc.) of the fixture containing the light source 205B and coordinates (e.g., x, y, and optionally z, relative to a floor plan of the venue in which the light source 205B is located) of at least one point (e.g., a corner) on the light fixture, the mobile device 115 may be able to determine its position within the venue based on identifying the at least one point on the light fixture, the orientation of the mobile device 115 with respect to the at least one point on the light fixture (using orientation sensors of the mobile device 115, e.g., an accelerometer and/or a gyroscope, and the information representing the shape of the light fixture), and the distance between the mobile device 115 and the at least one point on the light fixture (using the angle of arrival of the light signal received from each light source 205B and the information representing the size of the light fixture). Thus, the mobile device 115 may be able to determine its position based on information received from a single light source, here, the light source 205B.

Note that although the light sources 205 in FIGS. 2 and 3 are illustrated in the shape of a typical single incandescent bulb, as would be appreciated, the light sources 205 may be arrays of bulbs having any shape or individual bulbs having shapes other than the shape illustrated.

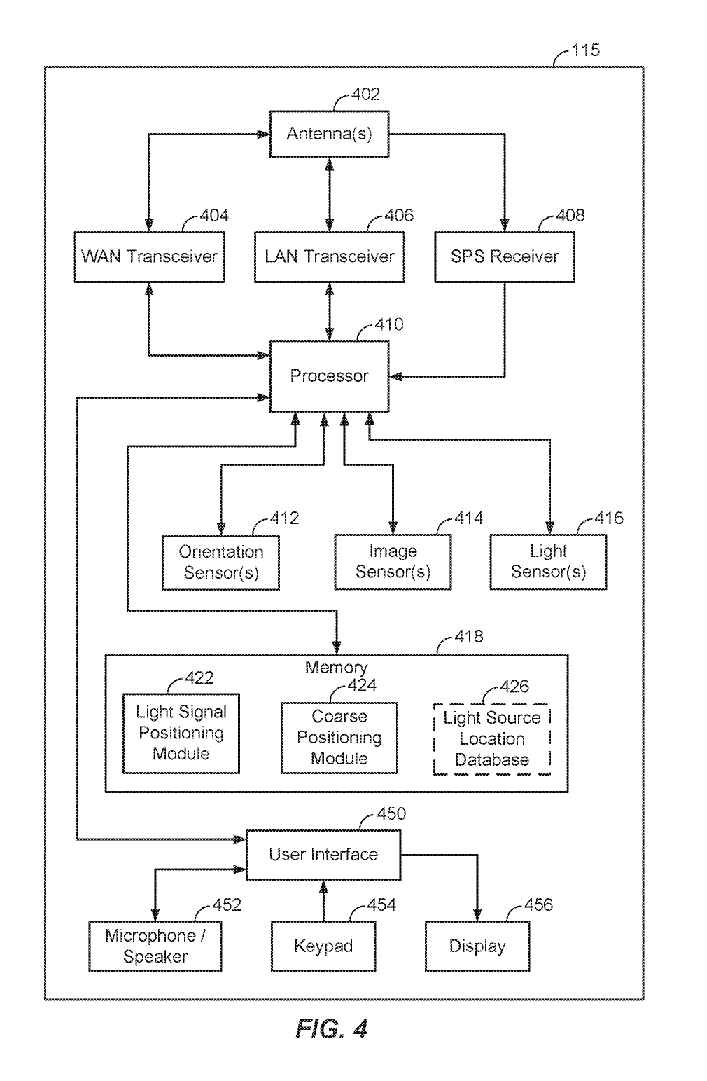

FIG. 4 is a block diagram illustrating various components of an exemplary mobile device 115. For the sake of simplicity, the various features and functions illustrated in the box diagram of FIG. 4 are connected together using a common bus that is meant to represent that these various features and functions are operatively coupled together. Those skilled in the art will recognize that other connections, mechanisms, features, functions, or the like, may be provided and adapted as necessary to operatively couple and configure an actual portable wireless device. Further, it is also recognized that one or more of the features or functions illustrated in the example of FIG. 4 may be further subdivided or two or more of the features or functions illustrated in FIG. 4 may be combined.

The mobile device 115 may include one or more wide area network (WAN) transceiver(s) 404 that may be connected to one or more antennas 402. The WAN transceiver 404 comprises suitable devices, hardware, and/or software for communicating with and/or detecting signals to/from WAN access points 105, and/or directly with other wireless devices within the system 100. In one aspect, the WAN transceiver 404 may comprise a code division multiple access (CDMA) communication system suitable for communicating with a CDMA network of wireless base stations; however in other aspects, the wireless communication system may comprise another type of cellular telephony network, such as, for example, time division multiple access (TDMA) or the Global System for Mobile Communications (GSM). Additionally, any other type of wide area wireless networking technologies may be used, for example, WiMAX (IEEE 802.16), etc.

The mobile device 115 may also include one or more WLAN and/or personal area network (PAN) transceivers 406 that may be connected to the one or more antennas 402. The one or more WLAN/PAN transceivers 406 comprise suitable devices, hardware, and/or software for communicating with and/or detecting signals to/from access points 105, and/or directly with other wireless devices within a network. In one aspect, the one or more WLAN/PAN transceivers 406 may include a Wi-Fi (802.11x) or Bluetooth® transceiver. Additionally, any other type of wireless networking technologies may be used, for example, Ultra Wide Band, ZigBee, wireless Universal Serial Bus (USB), etc.

A satellite positioning system (SPS) receiver 408 may also be included in the mobile device 115. The SPS receiver 408 may be connected to the one or more antennas 402 for receiving satellite signals. The SPS receiver 408 may comprise any suitable hardware and/or software for receiving and processing SPS signals. The SPS receiver 408 requests information and operations as appropriate from the other systems, and performs the calculations necessary to determine the mobile device's 115 position using measurements obtained by any suitable SPS algorithm.

One or more orientation sensors 412 may be coupled to a processor 410 to provide movement and/or orientation information that is independent of motion data derived from signals received by the WAN transceiver 404, the local area network (LAN) transceiver 406, and the SPS receiver 408. For example, the one or more orientation sensors 412 may comprise one or more accelerometers and/or a three-dimensional (3-D) accelerometer, a gyroscope, a geomagnetic sensor (e.g., a compass), a motion sensor, and/or any other type of movement detection sensor. Moreover, the one or more orientation sensors 412 may include a plurality of different types of devices and combine their outputs in order to provide motion information. For example, the one or more orientation sensors 412 may use a combination of a multi-axis accelerometer and orientation sensors to provide the ability to compute positions in two-dimension (2-D) and/or 3-D coordinate systems. Although not shown, the mobile device 115 may further include an altimeter (e.g., a barometric pressure altimeter).

One or more image sensors 414 may also be coupled to the processor 410. The one or more image sensors 414 may be image sensors containing an array of photodiodes (e.g., a complementary metal-oxide semiconductor (CMOS) image sensor), and may correspond to a front and/or a rear-facing camera of the mobile device 115.

One or more light sensors 416 (e.g., photosensors or photodetectors) may also be coupled to the processor 410. The one or more light sensors 416 may be one or more photodiodes, photo transistors, etc.

The processor 410 may include one or more microprocessors, microcontrollers, and/or digital signal processors that provide processing functions, as well as other calculation and control functionality. The processor 410 may also be coupled to memory 418 for storing data and software instructions for executing programmed functionality within the mobile device 115. For example, the processor 410 may be operatively configurable based on instructions in the memory 418 to selectively initiate one or more routines that exploit motion data for use in other portions of the mobile device 115. The memory 418 may be on-board the processor 410 (e.g., within the same integrated circuit (IC) package), and/or the memory 418 may be external memory to the processor 410 and functionally coupled over a data bus.

A number of software modules and data tables may reside in memory 418 and be utilized by the processor 410 in order to manage both communications and positioning determination functionality as described herein. As illustrated in FIG. 4, memory 418 may include at least a light signal positioning module 422, a coarse positioning module 424, and an optional light source location database 426. As will be described further herein, the light source location database 426 may be populated with known locations of all or a subset of the light sources 205 installed in the venue in which the mobile device 115 is located. One should appreciate that the organization of the memory contents as shown in FIG. 4 is merely exemplary, and as such the functionality of the modules and/or data structures may be combined, separated, and/or be structured in different ways depending upon the implementation of the mobile device 115.

The processor 410, the one or more orientation sensors 412, and the coarse positioning module 424 may cooperatively perform positioning operations based on dead reckoning (DR) to estimate the position of the mobile device 115 when other methods of estimating the position of the mobile device 115 are not available, such as when the mobile device 115 is in an indoor environment. Dead reckoning is the process of calculating the current position of the mobile device 115 by using a previously determined position, or fix, and advancing that position based upon known or estimated speeds over elapsed time and course, for example, as sensed by the one or more orientation sensors 412. More specifically, one or more accelerometers of the one or more orientation sensors 412 and one or more gyroscopes of the one or more orientation sensors 412 continuously calculate the movement, orientation, and velocity of the mobile device 115 to calculate changes in position of the mobile device 115 from the last known position fix.

The processor 410, the one or more image sensors 414 and/or the one or more light sensors 416, and the light signal positioning module 422 may cooperatively perform positioning operations based on light signals from one or more light sources 205 to estimate the position of the mobile device 115. For example, the one or more image sensors 414 and/or the one or more light sensors 416 may receive and decode the light signal(s) to obtain identification information for the light source(s) 205. Based on the identification information, the WAN transceiver 404 and/or the LAN transceiver 406 may obtain the location(s) of the light source(s) 205 from a local server (e.g., a location server, such as location server 170, associated with the venue in which the mobile device 115 is located). Alternatively, if location information for the light source(s) 205 was previously downloaded and stored in the light source location database 426, the processor 410 can retrieve the location(s) of the light source(s) 205 from the light source location database 426. Based on the location of the light source(s) 205, the angle of arrival of the light signal, and optionally the size (e.g., dimensions), shape, orientation, coordinates of a point within the light source(s) 205, or any combination thereof, the light signal positioning module 422, as executed by the processor 410, may determine positioning information, such as the location of the mobile device 115.

While the modules shown in FIG. 4 are illustrated as being contained in the memory 418, it is recognized that in certain implementations such procedures may be provided for or otherwise operatively arranged using other or additional mechanisms. For example, all or part of the light signal positioning module 422 and/or the coarse positioning module 424 may be provided in firmware. Additionally, while in this example the light signal positioning module 422 and/or the coarse positioning module 424 are illustrated as being separate features, it is recognized, for example, that such procedures may be combined together as one procedure or perhaps with other procedures, or otherwise further divided into a plurality of sub-procedures.

The mobile device 115 may further include a user interface 450 that provides any suitable interface systems, such as a microphone/speaker 452, keypad 454, and display 456 that allows user interaction with the mobile device 115. The microphone/speaker 452 provides for voice communication services using the WAN transceiver 404 and/or the LAN transceiver 406. The keypad 454 comprises any suitable buttons for user input. The display 456 comprises any suitable display, such as, for example, a backlit liquid crystal display (LCD) display, and may further include a touch screen display for additional user input modes.

As used herein, the mobile device 115 may be any portable or movable device or machine that is configurable to acquire wireless signals transmitted from, and transmit wireless signals to, one or more wireless communication devices or networks. As shown in FIG. 1, the mobile device 115 is representative of such a portable wireless device. Thus, by way of example but not limitation, the mobile device 115 may include a radio device, a cellular telephone device, a computing device, a personal communication system (PCS) device, or other like movable wireless communication equipped device, appliance, or machine. The term “mobile device” is also intended to include devices which communicate with a personal navigation device (PND), such as by short-range wireless, infrared, wire line connection, or other connection, regardless of whether satellite signal reception, assistance data reception, and/or position-related processing occurs at the device or at the PND. Also, the term “mobile device” is intended to include all devices, including wireless devices, computers, laptops, tablets, smartphones, etc. that are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above is also considered a “mobile device.”

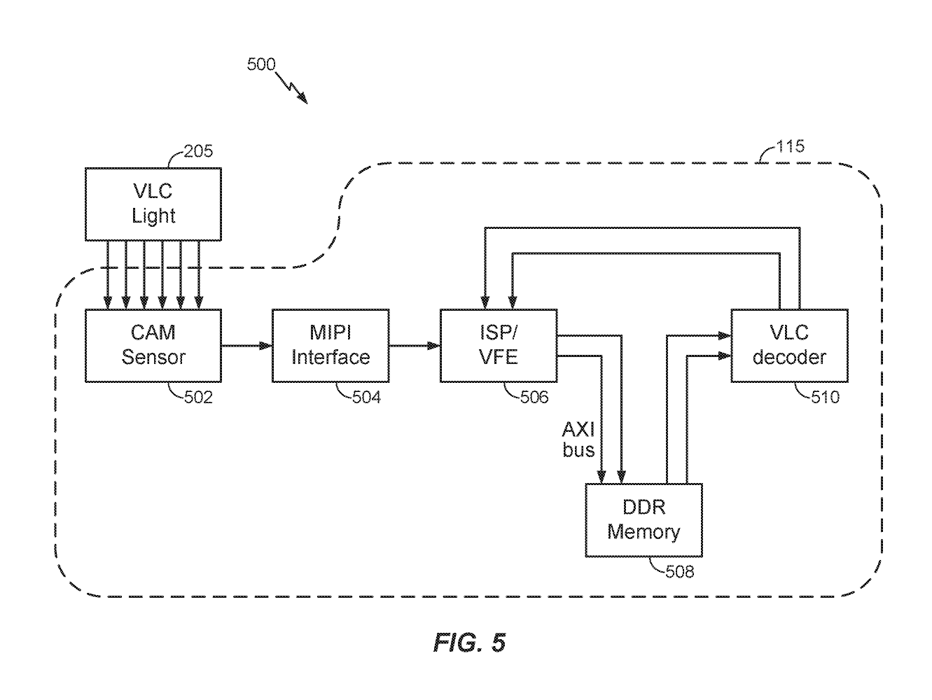

FIG. 5 is a block diagram of an exemplary system 500 illustrating the processing of VLC signals in an exemplary mobile device 115. As illustrated in FIG. 5, the camera sensor 502 (which may correspond to the image sensor 414 in FIG. 4) detects a VLC signal from a VLC light source 205. In an aspect, the camera sensor 502 may have a “rolling shutter,” where each line (i.e., each row or column) of the camera sensor 502 is exposed at different times (usually sequentially from top to bottom, right to left, etc., hence the term “rolling”). Based on this feature, when capturing images of a VLC light source 205 with rapidly changing brightness, the camera sensor 502 will deliver an image that contains bright and dark stripes. By measuring the width of the stripes, the frequencies of the driving current or driving voltage of the VLC light source 205 may be calculated and the transmitted identification information may thus be restored.

The camera sensor 502 sends data representing the detected VLC signal over the Mobile Industry Processor Interface (MIPI) interface 504 to the Image Signal Processor (ISP)/Video Front-end Engine (VFE) 506. The ISP/VFE 506 buffers the data representing the VLC signal into the Double Data Rate (DDR) memory 508 over an Advanced eXtensible Interface (AXI) bus. The VLC decoder 510 accesses the buffered data representing the VLC signal from the DDR memory 508 and decodes/demodulates it. The VLC decoder 510 then passes the decoded/demodulated data to the ISP/VFE 506 for further processing. For example, the ISP/VFE 506 may perform positioning operations, such as those described above, using the decoded/demodulated data.

A rolling shutter can run at very high frame rates (e.g., 240 frames-per-second (fps)) in order to capture the high-speed VLC signal from a VLC light source 205. As such, the ISP/VFE 506 needs to write 240 image frames per second to the DDR memory 508 over the AXI bus, which consumes a significant amount of bandwidth. In general, the camera sensor 502 acts as a VLC input, since it reads data line by line, and not until the ISP/VFE 506 is the frame structured. The ISP/VFE 506 then writes the structured frame to the DDR memory 508 using the write masters. The structured frame is then sent to the VLC decoder 510 for VLC processing. As will be appreciated, the ISP/VFE 506 consumes a significant amount of power since it copies the image frames to the DDR memory 508 and also processes the decoded/demodulated VLC data.

In addition to the power consumed by the ISP/VFE 506, another issue with VLC communications/positioning is that the camera sensor 502 runs continuously when the mobile device 115 is in VLC mode to detect signals from any visible VLC light sources 205. Further, VLC is generally only available at indoor locations, and as such, it is unlikely that the mobile device 115 will detect a VLC light source 205 when it is outdoors, even if the mobile device 115 is in VLC mode. As such, it would be beneficial for the mobile device 115 to be able to perform a power-efficient scan for VLC light sources 205.

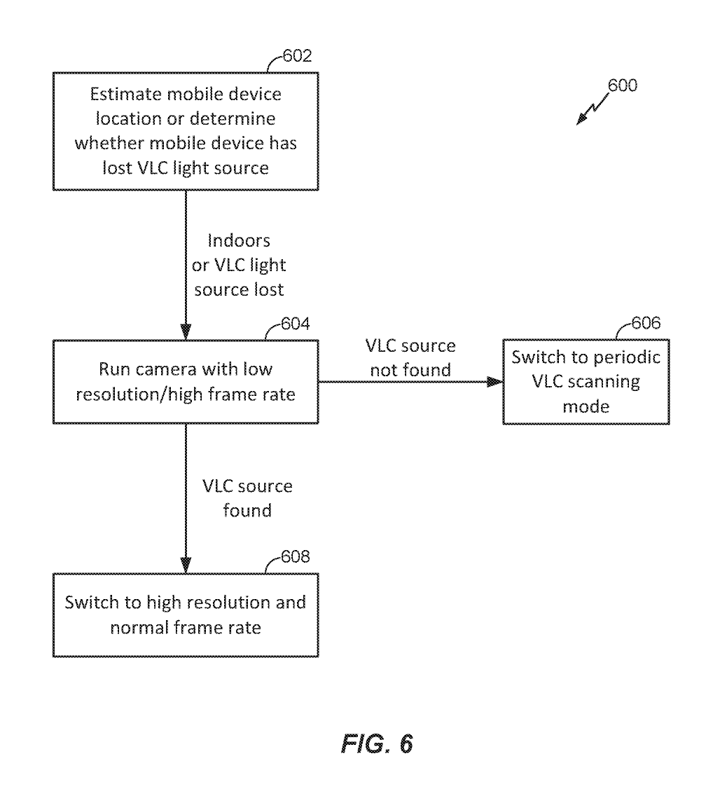

FIG. 6 illustrates an exemplary flow 600 for performing a power-efficient scan for VLC light sources 205 according to at least one aspect of the disclosure. The flow 600 may be performed by the mobile device 115. The flow 600 may be performed when the mobile device 115 is in VLC mode, such as when the mobile device 115 is running a VLC application.

At 602, the mobile device 115 determines whether or not it is located at an indoor location or whether or not it has lost view of a VLC light source 205. The mobile device 115 can determine whether it is located indoors or outdoors using various heuristics. For example, if received SPS signals are weak, the mobile device 115 can determine that it is likely indoors (due to the walls of the building causing attenuation of the SPS signals). As another example, the mobile device 115 can estimate whether it is indoors or outdoors based on the sound characteristics of its surroundings/environment. For example, if the mobile device 115 (e.g., microphone 452) detects some reverberation effects, it may determine that it is at an indoor location, whereas if the mobile device 115 detects wind noise, it may determine that it is at an outdoor location. As will be appreciated, there may be other heuristics that the mobile device 115 can use to determine whether it is located indoors or outdoors.

The mobile device 115 can determine whether it has lost view of a VLC light source 205 based on sensor data from the light sensor 416. For example, if sensor data from the light sensor 416 indicates that the light sensor 416 was not detecting light and is now detecting light (e.g., the user took the mobile device 115 out of his or her pocket), the mobile device 115 can determine that it has lost view of any previous VLC light source 205 that it may have detected and needs to acquire a new VLC signal from a different VLC light source 205 (or in some cases to reacquire the previous VLC signal from the previous VLC light source 205).

At 604, if the mobile device 115 is indoors or has lost view of a VLC light source 205, the mobile device 115 can perform a power-efficient scan for any visible VLC light sources 205. Specifically, the mobile device 115 can enable the camera sensor 502 (or the image sensor 414) in a low resolution (e.g., less than or equal to 640 by 480 pixels) and high frame rate (e.g., greater than 30 fps) mode to detect whether or not there are any VLC light sources 205 visible. By running the camera sensor 502 at a lower resolution, the mobile device 115 reduces the amount of power used by the camera sensor 502, while at the same time still being able to determine whether there are any VLC light sources 205 visible to the mobile device 115. Running the camera sensor 502 at a lower resolution also reduces memory usage (and by extension the power needed to operate the memory), since the ISP/VFE 506 does not need to copy as much image data to the DDR memory 508 as would be necessary if the camera sensor 502 were operating at a higher resolution. By running the camera sensor 502 at a higher frame rate, the mobile device 115 reduces the time it takes to determine whether there any VLC light sources 205 visible to the mobile device 115 (i.e., latency), since running the camera sensor 502 at the higher frame rate allows the mobile device 115 to detect a VLC light source 205 faster. Note, however, that if latency is not an issue, the mobile device 115 can run the camera sensor 502 at a lower frame rate (e.g., less than or equal to 30 fps) for increased power efficiency.

At 606, if the camera sensor 502 does not detect a VLC light source 205, the mobile device 115 can switch to a periodic scanning mode. If the camera sensor 502 does not detect a VLC light source within some threshold period of time or threshold number of periodic scans, the mobile device 115 can switch to a non-VLC mode (e.g., a mode in which the mobile device 115 does not attempt to detect VLC light sources). If the mobile device 115 is running a VLC-enabled application, the application may notify the user that it has switched to a non-VLC mode.

At 608, if the camera sensor 502 does detect a VLC light source 205, however, the mobile device 115 can switch to high resolution (e.g., greater than 640 by 480 pixels) and normal frame rate (e.g., 30 to 60 fps) in order to obtain a better VLC signal from the VLC light source 205 than could be obtained at the lower resolution and lower frame rate of the power-efficient scanning mode. The mobile device 115 (e.g., the VLC decoder 510) can then start decoding the detected VLC signal.

Note that the “high” resolution may be the resolution at which the camera sensor 502 is normally operated (e.g., when the camera sensor 502 is not in the power-efficient scanning mode), which may have been set by the user or may be a default value set by the manufacturer. Alternatively, the “high” resolution may be the highest, or one of the highest, resolutions at which the camera sensor 502 can be operated. As such, the “high” resolution may be referred to herein as the “normal,” “default,” “highest,” or “full” resolution of the camera sensor 502. Further note that the “normal” frame rate may be the frame rate at which the camera sensor 502 is normally operated (e.g., when the camera sensor 502 is not in the power-efficient scanning mode), which may have been set by the user or may be a default value set by the manufacturer.

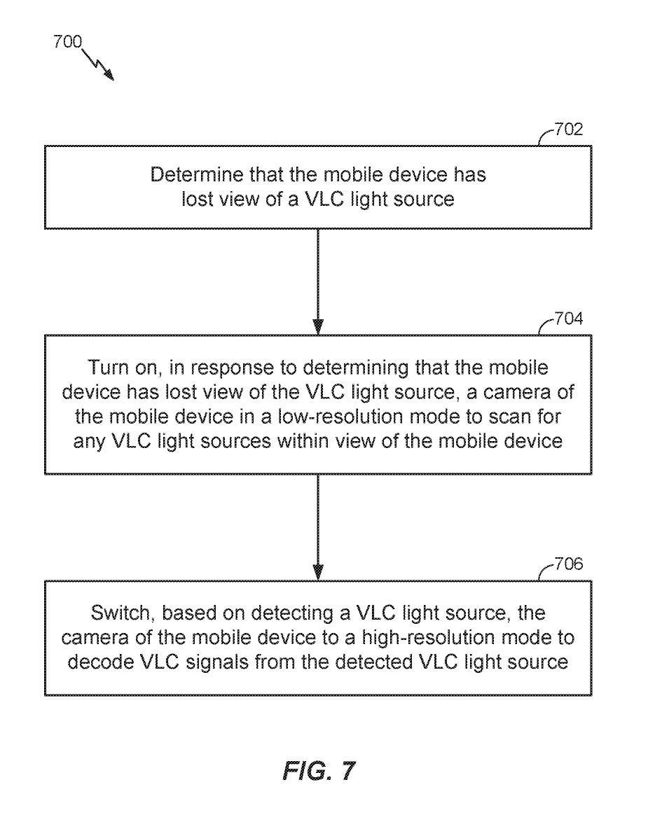

FIG. 7 is a flowchart of an exemplary method 700 for power efficient VLC scanning according to an aspect of the disclosure. The method 700 may be performed by the mobile device 115. More specifically, in an aspect, the method 700 may be performed by the processor 410 in conjunction with the image sensor 414 and the light signal positioning module 422, for example. In another aspect, the method 700 may be performed by the ISP/VFE 506 in conjunction with the camera sensor 502. However, for simplicity, the method 700 is described as being performed by the mobile device 115.

At 702, the mobile device 115 determines that it has lost view of a VLC light source 205. At 704, the mobile device 115 turns on, in response to determining that it has lost view of the VLC light source 205 at 702, the camera sensor 502 in a low-resolution mode (e.g., less than or equal to 640 by 480 pixels) to scan for any VLC light sources 205 within view of the mobile device 115. At 706, the mobile device 115 switches, based on detecting a VLC light source 205, the camera sensor 502 to a high-resolution mode (e.g., greater than 640 by 480 pixels) to decode VLC signals from the detected VLC light source 205.

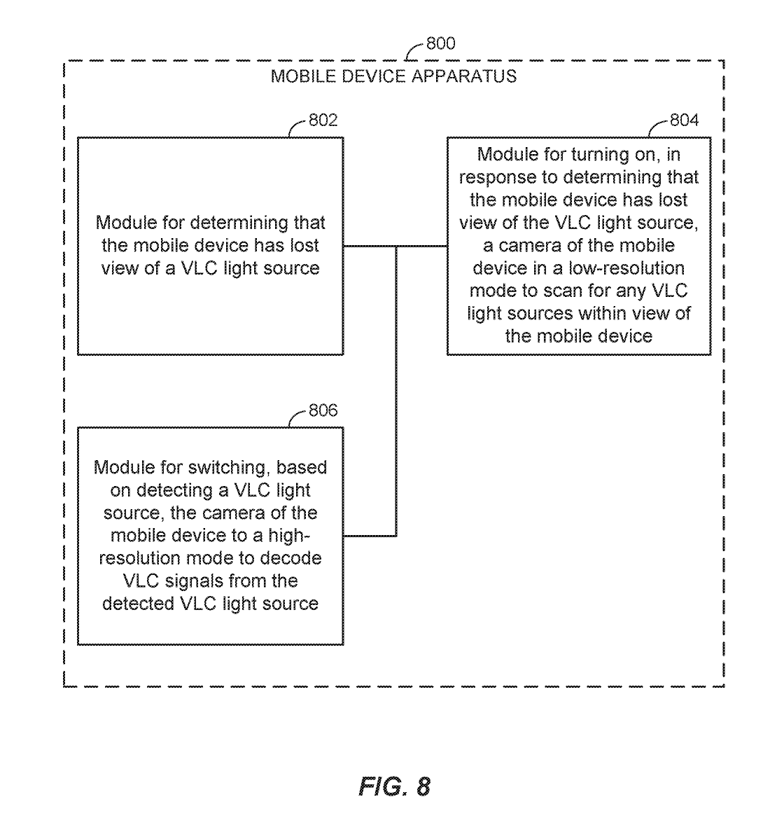

FIG. 8 illustrates an example mobile device apparatus 800 represented as a series of interrelated functional modules. A module for determining 802 may correspond at least in some aspects to, for example, a processing system, such as the processor 410 in conjunction with the image sensor 414 and the light signal positioning module 422 or the ISP/VFE 506 in conjunction with the camera sensor 502, as discussed herein. A module for turning on 804 may correspond at least in some aspects to, for example, a processing system, such as the processor 410 in conjunction with the image sensor 414 and the light signal positioning module 422 or the ISP/VFE 506 in conjunction with the camera sensor 502, as discussed herein. A module for switching 806 may correspond at least in some aspects to, for example, a processing system, the processor 410 in conjunction with the image sensor 414 and the light signal positioning module 422 or the ISP/VFE 506 in conjunction with the camera sensor 502, as discussed herein.

The functionality of the modules of FIG. 8 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 8, as well as other components and functions described herein, may be implemented using any suitable means. Such means also may be implemented, at least in part, using corresponding structure as taught herein. For example, the components described above in conjunction with the “module for” components of FIG. 8 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random-access memory (RAM), flash memory, read-only memory (ROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. An apparatus for power efficient visible light communication (VLC) scanning, comprising:
at least one processor of a mobile device configured to:
determine that the mobile device has lost view of a VLC light source;
turn on, in response to the determination that the mobile device has lost view of the VLC light source, a camera of the mobile device in a low-resolution mode to scan for any VLC light sources within view of the mobile device; and
switch, based on detection of a detected VLC light source, the camera of the mobile device to a high-resolution mode to decode VLC signals from the detected VLC light source.

2. The apparatus of claim 1, wherein the at least one processor being configured to turn on the camera of the mobile device in the low-resolution mode further comprises the at least one processor being configured to turn on the camera of the mobile device in a high frame rate setting, wherein the low-resolution mode comprises a resolution less than or equal to 640 by 480 pixels, and wherein the high frame rate setting comprises a frame rate greater than 30 frames per second.

3. The apparatus of claim 1, wherein the at least one processor being configured to turn on the camera of the mobile device in the low-resolution mode further comprises the at least one processor being configured to turn on the camera of the mobile device in a low frame rate setting, wherein the low-resolution mode comprises a resolution less than or equal to 640 by 480 pixels, and wherein the low frame rate setting comprises a frame rate of less than or equal to 30 frames per second.

4. The apparatus of claim 1, wherein the at least one processor being configured to switch the camera of the mobile device to the high-resolution mode comprises the at least one processor being configured to switch the camera of the mobile device to a full resolution setting and a normal frame rate setting, wherein the full resolution setting comprises a resolution greater than 640 by 480 pixels, and wherein the normal frame rate setting comprises a frame rate of 30 to 60 frames per second.

5. The apparatus of claim 1, wherein the at least one processor is further configured to:
switch, based on not detecting any VLC light source, to a periodic VLC scanning mode.

6. The apparatus of claim 5, wherein the at least one processor is configured to stop periodically scanning for VLC light sources based on not detecting any VLC light source within a threshold period of time or a threshold number of scans.

7. The apparatus of claim 6, wherein the at least one processor is further configured to:
turn off VLC detection based on detection that the mobile device has moved to a non-VLC-enabled venue.

8. The apparatus of claim 1, wherein the at least one processor is further configured to:
determine a location of the mobile device utilizing non-VLC location techniques;
determine that the mobile device is located within a VLC-enabled venue based on the determination of the location of the mobile device; and
enable VLC detection based on the determination that the mobile device is located within the VLC enabled venue.

9. The apparatus of claim 8, wherein the non-VLC location techniques comprise one or more of global navigation satellite system (GNSS) signal reception, wireless local area network (WLAN) signal reception, or wide area network (WAN) signal reception.

10. The apparatus of claim 8, wherein the at least one processor is further configured to:
switch, in response to determining that the mobile device is located within the VLC-enabled venue, to a VLC mode, wherein the at least one processor being configured to switch to the VLC mode comprises the at least one processor being configured to turn on the camera of the mobile device in the low-resolution mode.

11. The apparatus of claim 1, wherein the at least one processor is further configured to:
enable VLC detection based on a launch of a VLC-enabled application for a VLC-enabled venue.

12. A method for power efficient visible light communication (VLC) scanning performed at a mobile device, comprising:
determining that the mobile device has lost view of a VLC light source;
turning on, in response to determining that the mobile device has lost view of the VLC light source, a camera of the mobile device in a low-resolution mode to scan for any VLC light sources within view of the mobile device; and
switching, based on detecting a detected VLC light source, the camera of the mobile device to a high-resolution mode to decode VLC signals from the detected VLC light source.

13. The method of claim 12, wherein turning on the camera in the low-resolution mode further comprises turning on the camera in a high frame rate setting, wherein the low-resolution mode comprises a resolution less than or equal to 640 by 480 pixels, and wherein the high frame rate setting comprises a frame rate greater than 30 frames per second.

14. The method of claim 12, wherein turning on the camera in the low-resolution mode further comprises turning on the camera of the mobile device in a low frame rate setting, wherein the low-resolution mode comprises a resolution less than or equal to 640 by 480 pixels, and wherein the low frame rate setting comprises a frame rate of less than or equal to 30 frames per second.

15. The method of claim 12, wherein switching the camera to the high-resolution mode comprises switching the camera to a full resolution setting and a normal frame rate setting, wherein the full resolution setting comprises a resolution greater than 640 by 480 pixels, and wherein the normal frame rate setting comprises a frame rate of 30 to 60 frames per second.

16. The method of claim 12, further comprising:
switching, based on not detecting any VLC light source, to a periodic VLC scanning mode.

17. The method of claim 16, further comprising stopping periodically scanning for VLC light sources based on not detecting any VLC light source within a threshold period of time or a threshold number of scans.

18. The method of claim 12, further comprising:
determining a location of the mobile device utilizing non-VLC location techniques;
determining that the mobile device is located within a VLC-enabled venue based on determining the location of the mobile device; and
enabling VLC detection based on determining that the mobile device is located within the VLC enabled venue.

19. The method of claim 18, wherein the non-VLC location techniques comprise one or more of global navigation satellite system (GNSS) signal reception, wireless local area network (WLAN) signal reception, or wide area network (WAN) signal reception.

20. A non-transitory computer-readable medium storing computer-executable instructions for power efficient visible light communication (VLC) scanning, the computer-executable instructions comprising:
at least one instruction to cause a mobile device to determine that the mobile device has lost view of a VLC light source;
at least one instruction to cause the mobile device to turn on, in response to determining that the mobile device has lost view of the VLC light source, a camera of the mobile device in a low-resolution mode to scan for any VLC light sources within view of the mobile device; and
at least one instruction to cause the mobile device to switch, based on detecting a detected VLC light source, the camera of the mobile device to a high-resolution mode to decode VLC signals from the detected VLC light source.
